(19) United States
(12) Patent Application Publication
(10) Pub. No.: US 2023/0040621 A1
(43) Pub. Date: Feb. 9, 2023

(54) GEOMETRIC COMPENSATIONS

(71) Applicant: Hewlett-Packard Development Company, L.P., Spring, TX (US)

(72) Inventors: Julia Almacellas Visa, Sant Cugat del Valles (ES); Manuel Freire Garcia, Sant Cugat del Valles (ES); Victor Diego Gutierrez, Sant Cugat del Valles (ES)

(21) Appl. No.: 17/904,752

(22) PCT Filed: Mar. 30, 2020
(86) PCT No.: PCT/US2020/025651

§ 371 Date: Aug. 22, 2022

(51) Int. Cl. B29C 64/386; B33Y 50/00; G05B 19/4099

(52) U.S. Cl. CPC B29C 64/386; B33Y 50/00; G05B 19/4099; G05B 2219/49023

(57) ABSTRACT

An example method includes obtaining a geometric compensation profile characterising a relationship between a location of an object within a first fabrication volume having a first depth of build material and a geometrical compensation to be applied to a model of said object. The method further includes determining that a first object is to be generated in a first build operation having a second fabrication volume which has a second depth. The method may further include determining a geometrical compensation to be applied to a model of the first object by: determining a first offset of the first object from the top of the second fabrication volume; identifying the geometrical compensation value associated with a location having the first offset from the top of the first fabrication volume; and determining the compensation to be applied to the model of the first object based on the identified geometrical compensation value.

### BACKGROUND

Additive manufacturing techniques may generate a three-dimensional object through the solidification of a build material, for example on a layer-by-layer basis. In examples of such techniques, build material may be supplied in a layer-wise manner and the solidification method may include heating the layers of build material to cause melting in selected regions. In other techniques, chemical solidification methods may be used.

### BRIEF DESCRIPTION OF DRAWINGS

Non-limiting examples will now be described with reference to the accompanying drawings, in which:

FIG. 1 is a flowchart of an example of a method of determining a geometrical compensation to be applied to a model of an object;

FIGS. 2A and 2B are simplified schematics of example fabrication volumes of an additive manufacturing apparatus;

FIG. 3 is flowchart of an example of a method for generating an object;

FIGS. 4A and 4B are examples of weighting functions;

FIGS. 5A and 5B are examples of cooling profiles for different depths within different build materials;

FIG. 6 is a simplified schematic drawing of an example apparatus;

FIG. 7 is a simplified schematic drawing of an example apparatus for additive manufacturing; and

FIGS. 8 and 9 are simplified schematic drawings of an example machine readable medium associated with a processor.

### DETAILED DESCRIPTION

Additive manufacturing techniques may generate a three-dimensional object through the solidification of a build material. In some examples, the build material is a powder-like granular material, which may for example be a plastic, ceramic or metal powder and the properties of generated objects may depend on the type of build material and the type of solidification mechanism used. In some examples the powder may be formed from, or may include, short fibres that may, for example, have been cut into short lengths from long strands or threads of material. Build material may be deposited, for example on a print bed and processed layer by layer, for example within a fabrication chamber. According to one example, a suitable build material may be PA12 build material commercially referred to as V1R10A “HP PA12” available from HP Inc.

In some examples, selective solidification is achieved through directional application of energy, for example using a laser or electron beam which results in solidification of build material where the directional energy is applied. In other examples, at least one print agent may be selectively applied to the build material and may be liquid when applied. For example, a fusing agent (also termed a ‘coalescence agent’ or ‘coalescing agent’) may be selectively distributed onto portions of a layer of build material in a pattern derived from data representing a slice of a three-dimensional object to be generated (which may for example be determined from structural design data). The fusing agent may have a composition which absorbs energy such that, when energy (for example, heat) is applied to the layer, the build material to which it has been applied heats up, coalesces and solidifies, upon cooling, to form a slice of the three-dimensional object in accordance with the pattern. In other examples, coalescence may be achieved in some other manner.

According to one example, a suitable fusing agent may be an ink-type formulation comprising carbon black, such as, for example, the fusing agent formulation commercially referred to as V1Q60A “HP fusing agent” available from HP Inc. Such a fusing agent may comprise any or any combination of an infra-red light absorber, a near infra-red light absorber, a visible light absorber and a UV light absorber. Examples of fusing agents comprising visible light absorption enhancers are dye based colored ink and pigment based colored ink, such as inks commercially referred to as CE039A and CE042A available from HP Inc.

In addition to a fusing agent, in some examples, a print agent may comprise a coalescence modifier agent, which acts to modify the effects of a fusing agent for example by reducing or increasing coalescence or to assist in producing a particular finish or appearance of an object, and such agents may therefore be termed detailing agents. In some examples, detailing agent may be used near outer edge surfaces of an object being generated to reduce coalescence. According to one example, a suitable detailing agent may be a formulation commercially referred to as V1Q61A “HP detailing agent” available from HP Inc. A coloring agent, for example comprising a dye or colorant, may in some examples be used as a fusing agent or a coalescence modifier agent, and/or as a print agent to provide a particular color for the object.

As noted above, additive manufacturing systems may generate objects based on structural design data. This may involve a designer designing a three-dimensional model of an object to be generated, for example using a computer aided design (CAD) application. The model may define the solid portions of the object. To generate a three-dimensional object from the model using an additive manufacturing system, the model data may comprise, or can be processed to derive, slices or parallel planes of the model. Each slice may define a portion of a respective layer of build material that is to be solidified or caused to coalesce by the additive manufacturing system.

During manufacturing of an object by additive manufacturing, particularly where heat may be applied to the object, deformations may occur resulting in an object being generated which does not have the expected dimensions. The particular deformations may depend on any or any combination of factors such as the build material used, the type of additive manufacturing, the location of the object within the fabrication chamber of the additive manufacturing apparatus, object volume and the like.

For example, it may be the case that, where an object is generated in a process which includes heat, additional build material may adhere to the object on generation. In one example, fusing agent may be associated with a region of the layer which is intended to fuse. However, when energy is supplied, build material of neighbouring regions may become heated and fuse to the outside of the object (in some examples, being fully or partially melted, or adhering to melted build material as powder). Therefore, a dimension of an object may be larger than the region(s) to which fusing agent is applied. In order to compensate for this effect, i.e. where it is anticipated that an object may tend to ‘grow’ during manufacture, the object volume as described in object model data may be reduced.

In other examples, objects may be smaller following object generation than is specified in object model data. For example, some build materials used to generate objects may shrink on cooling. Therefore, an object volume in object model data may be increased to compensate for the anticipated reduction in volume.

In some examples, the particular deformations may depend on the object’s location within the fabrication chamber of the additive manufacturing apparatus. This may be because the thermal characteristics vary throughout the fabrication chamber, for example there may be small differences in temperature in different locations. In some examples, objects which are near the bottom of the chamber may be maintained at a higher temperature for a longer period than those located near the top of the fabrication chamber because objects generated near the bottom of the chamber will be generated near the start of the fabrication process, whereas those near the top will be generated later in the process. This may lead to a difference in cooling rates, which may impact deformations. Other differences may exist, for example due to inhomogeneities in heating or cooling, and/or heating or cooling rates, which may for example be associated with factors such as the location of heating or cooling elements and/or a proximity of an object being generated to walls of the fabrication chamber which may affect the cooling rate of build material.

A particular object may be subject to mechanisms which result in growth and/or shrinkage, and the appropriate transformation to apply may be influenced by the different degrees to which an object may be affected by such processes.

Such compensations may be applied using geometrical transformation(s) which may include scaling and/or offsets. For example, a geometrical transformation may comprise at least one scaling factor and/or at least one offset value, and in some examples associate a scaling factor and/or offset value with at least one of three orthogonal axes (e.g. x, y and z, wherein the z-direction is taken herein to be the direction perpendicular to layers of deposited build material and x- and y-directions are in the plane of the deposited layers). A scaling factor may be used to multiply object dimensions in the direction of at least one axis by a value, which may be greater than 1 in order to increase the dimension(s) and less than 1 to reduce the dimension(s), or equal to 1 to have no effect. The scaling factor may be applied to dimensions of an object model, for example being applied to a mesh model of the object.

An offset may specify, for example by a specified distance or a number of defined voxels (i.e. 3D pixels), an amount to add or remove from a surface of the object (or a perimeter within a layer). For example, an offset distance in an axis may be specified and the object may be eroded or may be dilated (i.e., inflated or enlarged) by this distance, for example by moving the vertices of a mesh in the case that the object model is a mesh model, or adding/subtracting a number of voxels in a voxelised model although other methods of providing an offset may be used in other examples.

In summary then, to compensate for anticipated deformations, a model describing the object to be generated may be modified before commencing the build process. The modifications may comprise a scaling, whereby the object is ‘stretched’ or ‘compressed’ along an axis or axes and/or a surface offset operation which comprises applying either an erosion or dilation operation to a surface of the object. The methods set out below are described with reference to scaling and offsets, although these methods may be combined with any other modification operation(s) to provide a transformed object model.

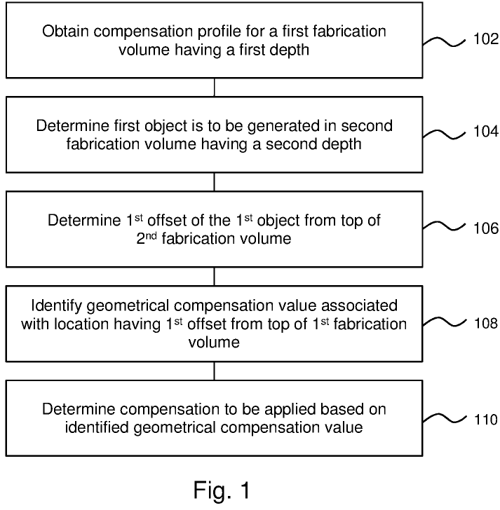

FIG. 1 is an example of a method, which may comprise a computer implemented method for determining a geometrical compensation to be applied to a model of an object.

The method comprises, in block 102 obtaining, using processing circuitry, a geometric compensation profile characterising a relationship between a location of an object within a first fabrication volume in a fabrication chamber of an additive manufacturing apparatus and a geometrical compensation to be applied to a model of said object, wherein geometrical compensation values (i.e. values for the geometrical compenension to be applied to object model data) are associated with different locations. The values of the geometrical compensation to be applied may therefore differ between locations. In other words, the geometrical compensation value for a first location may be different from that for a second location. In this example, the first fabrication volume has a first depth of build material.

The geometric compensation profile may comprise data describing how to compensate for anticipated deformations of an object to be generated, wherein the anticipated deformation may be affected by the intended location of generation of the object within the fabrication chamber. For example, it may comprise data representing geometrical transformations, such as offset and/or scaling transformations described above, to be applied to models of objects to be generated within the fabrication chamber as a function of their position within the fabrication chamber. Other factors may also be considered when determining the geometrical compensations to be applied to an object model, in addition to the geometric compensation profile, for example based on the material, dimensions (e.g. object volume), type or intended dimensional accuracy of the object to be generated, and the like.

In some examples the geometric compensation profile may comprise data describing a compensatory geometrical transformation to be applied at a plurality of different locations, wherein the locations correspond to different depths within the fabrication chamber. In some examples the geometric compensation profile may comprise data describing a compensatory geometrical transformation to be applied at a plurality of different points or nodes within the fabrication chamber. For example, the fabrication chamber may be notionally divided into a grid, which may be a regularly spaced grid, and each intersection point in the grid is a node which may be associated with at least one geometrical transformation value. For example, a node in the grid may be associated with at least one scaling factor, at least one offset value and/or any other modification value to be applied to objects which are generated at a location corresponding to that node. For example, the geometrical transformation value(s) of a node may be applied to the model of an object which is intended to be generated such that its centre of mass will coincide with the location of the node within the fabrication chamber, or some other definable point of the object is aligned with the location of the node. Objects to be generated at locations between nodes may for example be assigned the values of the closest node, or the values of the transformations to be applied may be generated by interpolation of the values for surrounding nodes, or the like. In other examples, geometrical transformation value for nodes which intersect with an intended volumetric extent of an object may be averaged.

In some examples the geometric compensation profile may be determined for each individual additive manufacturing apparatus or each fabrication chamber. In other examples the geometric compensation profile may be determined for a type or class of additive manufacturing apparatus or fabrication chamber. The geometric compensation profile may be determined empirically through measurements of objects generated using one or more additive manufacturing apparatus and/or by use of computer aided modelling of thermal characteristics of the fabrication chamber. In some examples, the geometric compensation profile may vary over the lifetime of the additive manufacturing apparatus and may be updated throughout the lifetime of the apparatus. For example, determining the model may comprise generating objects and determining if the dimensions of the objects are different from intended dimensions. If that is the case, then the scaling and offsets which, if applied to the object models prior to generation would have resulted in the objects having their intended dimensions may be determined, for example as an average, or using data fitting techniques.

As mentioned above, the obtained geometric compensation profile describes the geometrical compensations to be applied when an object is to be generated within a first fabrication volume having a first depth of build material. In some examples, the first depth of build material is the greatest depth of build material which the additive manufacturing apparatus is capable of using when generating objects.

In order to make economic use of an additive manufacturing apparatus, it may be intended to build as many objects within a single build operation as possible, and therefore use the greatest fabrication volume the additive manufacturing apparatus is capable of. However, in some circumstances, it may be intended to build a smaller number of objects, in which case it is more economical to use a fabrication volume which is smaller than the greatest fabrication volume possible. In other examples, the geometry of the objects to be generated may result in a fabrication volume which is less than the greatest possible fabrication volume. In these examples, a fabrication volume may be used which has a smaller depth than the greatest possible depth of fabrication volume. This is achieved by depositing fewer layers of build material during a build process.

The method comprises, in block 104, determining, using processing circuitry, that a first object is to be generated in a first build operation. In this example, the first build operation has a second fabrication volume which has a second depth, wherein the second depth is less than the first depth. For example, the fabricaiton chamber may be ‘less than full’ during the first build operation.

When an object, or objects, are to be generated they may be arranged within a fabrication volume based on a number of parameters, for example quantity of build material used, time taken to generate the objects and part quality if build in that arrangement. A spatial arrangement of objects may be selected such that the depth of build material used is less than the greatest depth of build material the additive manufacturing apparatus is capable of using. By using a smaller depth of build material, the quantity of material used and the time taken to generate the objects are reduced. Furthermore, it may be uneconomical to use a full fabrication volume when the objects may be generated in a smaller fabrication volume. Therefore, the objects may be generated in the second fabrication volume, which is less than the first fabrication volume.

However, the depth of build material used can affect the cooling profile of the build material during and after a build operation. For example, if a fabrication volume with greater depth of build material is used, then build material near the bottom of the fabrication volume may take longer to cool (i.e. cools more slowly) compared with a fabrication volume with a smaller depth of build material. This may be because the upper layers insulate the lower layers, reducing heat loss to the environment above the fabrication volume. Furthermore, when a greater depth of build material is used, more layers of build material are deposited which leads to more cycles of depositing and heating layers, which in turn means more heat being provided to heat the build material, which may maintain the lower layers at a higher temperature for longer. Therefore, the cooling profiles for fabrication volumes of different depths can vary significantly, and this in turn may impact the type and extent of deformations objects undergo. Therefore, in this example, the method continues by determining a compensation to be applied, given that the object is to be generated in a second depth, which may in turn indicate a ‘less than full’ fabrication chamber.

In particular, in this example, the method comprises determining, using processing circuitry, a geometrical compensation to be applied to a model of the first object.

Determining the geometrical compensation comprises, in block 106, determining a first offset (i.e. a spacing) of the first object from the top of the second fabrication volume. The method may have previously determined the second depth of build material to be used and the position where the first object is to be generated within the second fabrication volume. The top of the second fabrication volume refers to the upper surface of the top, or final, layer of build material which is deposited. The offset is a measure of the distance from the first object to this surface. The offset may for example be measured from the centre of a bounding box associated with an object, wherein a bounding box is a shape enclosing the object model, and is placed within a ‘virtual’ fabrication chamber at a position indicating the intended location of object generation within an actual fabrication chamber. In some examples, the bounding box is a minimum cuboid which encloses an object or, in other examples, a larger cuboid which defines a region in which other objects should not be generated (for example to provide an intended minimum spacing and thereby control thermal interaction). In other examples, the offset may be measured from the centre of the object in its intended generation location, which may be determined by calculating the position of the centre of mass of the first object object in its intended generation location. In other examples, the offset may be measured from the uppermost or lowermost portion of the object (e.g. any location having the highest or lowest Z value for that object) or in principle any other location representative of the object’s location. Where there are multiple objects to be generated in a build operation, a consistent measuring technique may be used for the objects to determine their respective offsets. It may be noted that the term ‘offset’ is also used herein to describe a type of geometrical transformation. This is a different type of offset to that determined in block 106.

Determining the geometrical compensation further comprises, in block 108, identifying, from the geometric compensation profile, the geometrical compensation value(s) associated with a location having the first offset from the top of the first fabrication volume. In an example, if an object is to be generated at a position 2 cm below the top surface of the second fabrication volume, then a corresponding position (i.e. same x and y coordinates) which is offset by 2 cm from the top surface of the first fabrication volume in the geometric compensation profile is identified. Thus, the identified geometrical compensation value may not be associated with a z coordinate of the intended location of object generation, but instead has a z coordinate determined from an offset from the upper surface.

In other words, if the object is to be generated in a location having coordinates (x₁, y₁, z₁) in a fabrication volume having a height represented by a maximum z coordinate zₘₐₓ₂, and the first depth is associated with a maximum z coordinate zₘₐₓ₁, then the z coordinate for which a corresponding geometrical compensation value is determined may be:

$${z}_{\text{offset}} = {z}_{\text{max1}} - \left({z}_{\text{max2}} - {z}_{1}\right) ,$$

and the geometrical compensation value(s) associated with (x₁, y₁, z_{offset}) may be identified.

Determining the geometrical compensation further comprises, in block 110, determining the compensation to be applied to the model of the first object based on the identified geometrical compensation value. Therefore, the determined compensation is based on a position in the geometric compensation profile which is the same distance below the surface as the distance between the intended object generation position of the first object and the top surface of the second fabrication volume. In some examples, the identified compensation value may be used directly as the compensation value for that object. However, in other examples, the identified value(s) may be combined with other at least one other value, as set out below.

While in theory it may be possible to determine a different geometric compensation profile for each depth of build material which it is contempated may be used in build operation, in practice it may be complicated to do so. For example, determining the geometric compensation profile may comprise performing several build processes to build a plurality of test objects and measuring the generated test objects. In some examples, 3 to 5 builds are used to characterise the build volume. Therefore, determining a different geometric compensation profile for each possible depth of build material for each additive manufacturing apparatus involves both time and cost. Even in examples where geometric compensation profiles are obtained using simulations, it may take a long time for the profile to be generated and may utilise specialised programs and significant amounts of processing power. However, according to the method of FIG. 1, the geometric compensation to be applied to an object to be generated in a fabrication volume smaller than the first fabrication volume may be obtained from the profile for the ‘full’ fabrication chamber without determining a different geometric compensation profile for each depth of build material.

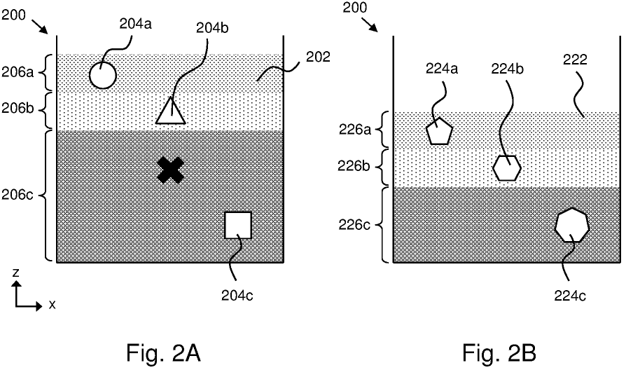

FIG. 2A shows a cross section of an example of a fabrication chamber 200 which has a first fabrication volume 202 and a first depth of build material. This cross section shows vertical cross section of the fabrication chamber 200 and three objects 204a-c to be generated in a fabrication process. A first object 204a is to be generated near the top of the fabrication volume in an upper portion 206a of build material. A second object 204b is to be generated in an intermediate portion 206b of build material, below the upper portion 206a. A third object 204c is to be generated in in a lower portion 206c of build material below the intermediate portion 206b and near the bottom of the fabrication volume 202.

Prior to generating the objects 204a-c, a geometrical compensation may be applied to object model data representing the objects 204a-c to compensate for deformations in the objects during object generation and cooling. The geometrical compensation to be applied may vary with the intended position of the objects 204a-c within the build volume and can be determined by looking up a corresponding position in a geometric compensation profile corresponding to the first fabrication volume 202. In some examples, when a first depth of build material is used, the corresponding position in the geometric compensation profile is looked up in the same manner, regardless of whether the object is to be generated in the upper portion 206a, the intermediate portion 206b or the lower portion 206c. In contrast, in examples herein, the geometrical compensation to be applied to an object model may be obtained in a different manner depending on which portion it the object is to by located on generation when a different depth of build material is used, for example as described with reference to FIG. 2B. As is further set out below, while the upper, intermediate and lower portions 206a-c shown in FIG. 2A may not be used in the methods herein, they may in theory be defined based on the thermal properties of the build material, for example as described below.

The first fabrication volume 202 may be the greatest depth of build material the additive manufacturing apparatus can produce/contain. The corresponding geometric compensation profile may be predetermined, for example having been determined when the additive manufacturing apparatus is manufactured or characterised.

FIG. 2B shows a cross section of an example of the fabrication chamber 200 with a second fabrication volume 222. The second fabrication volume 222 has a depth of build material which is smaller than the depth of build material in the first fabrication volume 202. This cross section shows vertical cross section of the fabrication chamber 200 and three objects 224a-c to be generated in a fabrication process. A first object 224a is to be generated near the top of the fabrication volume in an upper portion 226a of build material. A second object 224b is to be generated in an intermediate portion 226b of build material, below the upper portion 206a. A third object 204c is to be generated in a lower portion 206c of build material below the intermediate portion 206b and near the bottom of the fabrication volume 202.

In this example, the first object 224a to be generated in the second fabrication chamber 222 is to be generated at a location having the same x and y coordinates as the first object 204a to be generated in the first fabrication chamber 202, and the same offset from the upper surface. In this example, the second object 224a to be generated in the second fabrication chamber 222 is to be generated at a location having the same x and y coordinates as the second object 204a to be generated in the first fabrication chamber 202, and the same offset from the upper surface. In this example, the third object 224c to be generated in the second fabrication chamber 222 is to be generated at a location having the same x, y and z coordinates as the third object 204c to be generated in the first fabrication chamber 202 (i.e. has the same offset from the base of the respective fabrication chambers).

In some examples a predetermined geometric compensation profile may exist for the first fabrication volume 202, but a corresponding profile may not have been predeteremined for the second fabrication volume 222. However, in examples herein, in order to determine the geometrical compensation to be applied to the objects 224a-c to be generated in the second fabrication volume 222, the geometric compensation profile for the first fabrication volume 202 may be used.

Without wishing to be bound by theory, the variation in deformation behaviour for build operations with different depths of build material may be associated with different rates of cooling within a fabrication chamber. For example, in the upper portion of build material 206a, 226a it may be the case that heat loss is dominated by cooling through the top surface of the fabrication volume 202, 222, for example heat may be lost to convection of air above the top surface of the fabrication volume 202, 222. However, in the lower portion of build material 206c, 226c it may be that cooling is dominated by heat loss through the side walls and the bottom of the fabrication chamber 200 as additional layers are added to insulate and, due to application of heat, reduce temperature gradients in the build material. When an object is to be generated in the intermediate portion 226b of the second fabrication volume 222, a combination of these effects may be felt.

In some methods herein, the volume may be divided into an upper portion and a lower portion. The upper portion may be considered to have a consistent depth, regardless of the overall depth of the built material in a given build operation. Objects in the upper portion may be treated based on their location within this upper portion, such that the offset from the upper surface is considered as described above. However, objects in the lower portion may be assigned the compensation value(s) associated directly with their x,y,z coordinates, regardless of the overall depth of the build material in a given build operation.

Therefore, the geometrical compensation to be applied to a model the first object 224a which is to be generated in the second fabrication volume 222 may be similar to the geometrical compensation to be applied to the model of the first object 204a which is to be generated in the first fabrication volume 202, despite their different z coordinates. For example, the geometrical compensation corresponding to the position of the first object 204a in the first fabrication volume 202 can be used as the geometrical compensation to apply to a model of the first object 224a in the second fabrication volume 222 in some examples (at least if no factors other than location are used in determining the compensation to apply). More generally, to determine the geometrical compensation to be applied to a model of an object to be generated in the upper portion 226a, a distance between the intended gernation location of the object and the top surface may be determined, and used to identify a suitable compensation value from the geometrical compensation profile for the first fabrication volume 202.

However, to determine the geometrical compensation to be applied to the model of the third object 224c which is to be generated in the second fabrication volume 222, a geometrical compensation corresponding to the intended position of the third object 204c in the first fabrication volume 202 may be used. In order to determine this position, a position the same distance from the bottom of the fabrication chamber 200 may be looked up in the geometric compensation profile wich was predetermined for the first build volume 202. More generally, in the lower portion, the offset from the bottom (usually the x,y,z location of the object) may be used directly to identify the compensation values to apply.

While in some examples, there may be no intermediate portion defined (i.e. the upper and lower portions may share a boundary), in other examples, the intermediate portion 206b, 226b is further defined, in which compensation values from the lower and upper portions may be combined, for example in a weighted average based on their position within the intermediate portion.

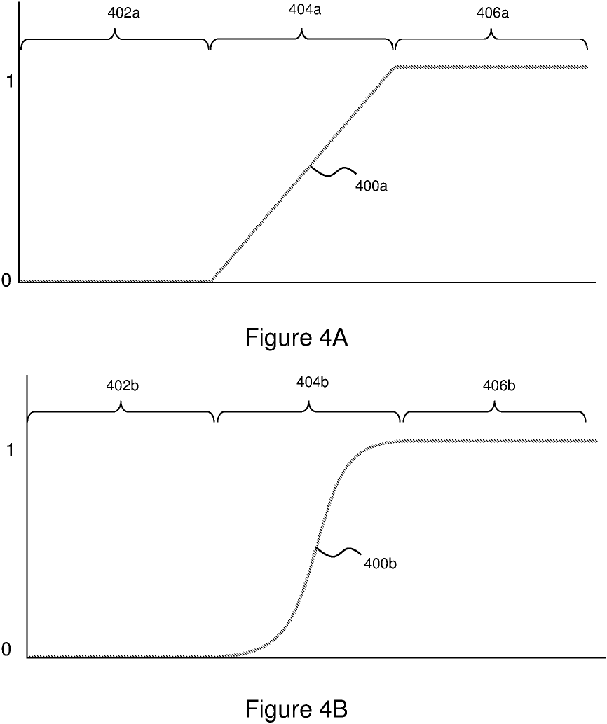

The intermediate portion may have a consistent depth regardless of the overall depth of the build volume, or may vary, for example in proportion to the depth. In this example, in order to determine a geometrical compensation to be applied to a model of the second object 224b, which is to be generated in the intermediate portion 206 of the second fabrication volume 222, at least two geometrical compensations relating to different locations in the first fabrication volume 202 may be combined. For example, the geometrical compensation corresponding to a position in the first fabrication volume 202 (marked by an X in FIG. 2A) which is the same distance from the bottom of the fabrication volume as the second object 224b is from the bottom of the second fabrication volume 222 may be used in determining the geometrical compensation to be applied. This geometrical compensation may be combined with a geometrical compensation obtained from a position in the geometric compensation profile of the first fabrication volume 202 which is the same distance from the top surface of the fabrication volume as the second object 224b from the top of the fabrication volume i.e. the position of the second object 204b in the first fabrication volume 202. In some examples, the combination may be a weighted sum or average of the individual geometrical compensations, for example as described in further detail in relation to FIGS. 4A and 4B.

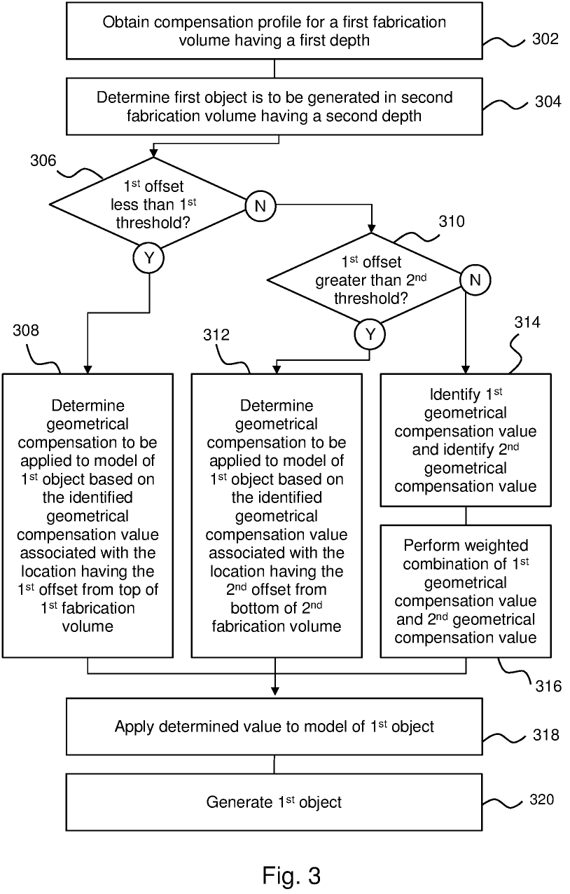

FIG. 3 is an example of a method, which may comprise a computer implemented method for determining a geometrical compensation to be applied to a model of an object to be generated in additive manufacturing. The method may be a method of determining geometrical compensation(s) to be applied to the second build volume 222 of FIG. 2B.

The method comprises, in block 302 obtaining, by at least one processor, a geometric compensation profile characterising a relationship between a location of an object within a first fabrication volume in a fabrication chamber of an additive manufacturing apparatus, the first fabrication volume having a first depth of build material, and a geometrical compensation to be applied to a model of said object, wherein different geometrical compensation values are associated with different locations. Block 302 corresponds to block 102 of FIG. 1.

The method comprises, in block 304, determining, using processing circuitry, that a first object is to be generated in a first build operation, the first build operation having a second fabrication volume which has a second depth, wherein the second depth is less than the first depth. Block 304 corresponds to block 104 of FIG. 1.

The method comprises, in block 306, determining a first offset of the first object from the top of the second fabrication volume, and determining if the first offset is less than a first threshold. In some examples, positions in which the first offset is less than the first threshold correspond to the object being in the upper portion 226a of FIG. 2B. The first threshold may correspond to a depth of build material in which cooling is dominated by cooling through the upper surface of the build material. Therefore, in some examples the first threshold may be based on thermal properties of the build material.

If it is determined that the first offset is less than the first threshold in block 306 then the method proceeds to block 308, which comprises determining the geometrical compensation to be applied. In block 308 determining the geometrical compensation to be applied comprises identifying, from the geometric compensation profile, the geometrical compensation value associated with a location having the first offset from the top of the first fabrication volume (wherein, in some examples, the location has the same position within a layer, for example the x and y coordinates of the intended object generation location) and determining the compensation to be applied to the model of the first object based on the identified geometrical compensation value. Block 308 corresponds to blocks 106 to 110 of FIG. 1.

If the determination in block 306 is negative, the method proceeds to block 310 which comprises determining when the first offset is greater than a second threshold. The second threshold may be greater than the first threshold. Positions in a fabrication volume for which this condition are positive may correspond to positions within the lower portion 226c of the second fabrication volume 222 in FIG. 2B. The second threshold may correspond to a depth of build material in which cooling is dominated by cooling through the sides and bottom of the build volume. Therefore, in some examples the second threshold may be based on thermal properties of the build material.

When the determination is positive the method proceeds to block 312 which comprises identifying the geometrical compensation by determining a second offset of the intended object generation location of the first object from the bottom of the second fabrication volume. This may be the z-coordinate of the intended location of generation. Identifying the geometrical compensation further comprises identifying, from the geometric compensation profile, the geometrical compensation value associated with a location having the second offset from the bottom of the first fabrication volume and determining the compensation to be applied to the model of the first object based on the identified geometrical compensation value (wherein, in some examples, the location has the same position within a layer, for example the x and y coordinates of the intended object generation location). Therefore, where the object is to be generated in a lower portion of the second fabrication volume, the geometrical compensation is based on the corresponding position in the geometric compensation profile of the first fabrication volume, or the x, y and z coordinates of the intended generation location may directly provide the the compensation to be applied.

When the determination in block 310 is negative, the first offset is greater than the first threshold and less than the second threshold and corresponds to positions which are in the intermediate portion 226b of FIG. 2B. In this case, the method continues to block 314, which comprises identifying, from the geometric compensation profile, a first geometrical compensation value associated with a location having the first offset from the top of the first fabrication volume (and in some examples, the same x and y locations as the intended object generation location). This first geometrical compensation value may be determined in a similar manner to the geometrical compensation value determined in block 308.

Block 314 further comprises determining the second offset of the first object from the bottom of the second fabrication volume and identifying, from the geometric compensation profile, a second geometrical compensation value associated with the location having the second offset from the bottom of the first fabrication volume, for example, the same z coordinate (and in some examples, the same x and y coordinates) as the intended object generation location. The second geometrical compensation value may be determined in a similar manner to the geometrical compensation value determined in block 312.

In some examples the method may identify both of the first geometrical compensation value and the second geometrical compensation value, regardless of the outcome of the comparisons in blocks 306 and 310, however if the determination in either of these blocks is positive, just one of the geometrical compensation values may be used in determining a compensation to apply.

When the first and second geometrical compensation values are determined, the method continues to block 316, which comprises determining the compensation to be applied to the model of the first object by combining the first geometrical compensation value and the second geometrical compensation value to identify the geometrical compensation to be applied.

In some examples combining the first geometrical compensation value and the second geometrical compensation value comprises performing a weighted combination of the first geometrical compensation value and the second geometrical compensation value.

In some examples, when the geometrical compensation value to be applied has been determined, the method further comprises block 318, in which the determined value is applied to the model of the first object. Some examples further comprise block 320, which comprises generating the first object in the first build operation, after applying the determined compensation to the object model, and determining object generation instructions based on the modified object model. The resulting object may therefore be appropriately compensated so that its dimensions are accurate with respect to the object’s intended dimensions.

A weighting function may be used in combining the first and second geometrical compensation values in order to determine the geometrical compensation to be applied to object model data in block 316. The weighting function may describe the relative contribution of the first and second geometrical compensation values as a function of the z-position of the object to be generated within the fabrication volume.

In an example, a first fabrication volume has a depth h₁ and a second fabrication volume of depth h₂. A geometric compensation profile, p(x, y, z), exists for the first fabrication volume, wherein x, y and z are positions of the first object to be generated within the fabrication volume. A weighting function f(z) may be used to describe how the first geometrical compensation value and the second geometrical compensation value are combined in the intermediate portion of the second fabrication volume.

Examples of weighting functions are shown in FIGS. 4A and 4B, each of which show a weighting function 400a, 400b plotted on an axis, wherein the horizontal axis is z (i.e. vertical position within the fabrication volume, measured from the bottom of the fabrication volume) and the vertical axis is the value of f(z). In each example the value of f(z) ranges from 0 at z=0 (the bottom of the fabrication volume) to f(z)=1 at the top of the fabrication volume.

Each plot 400a, 400b comprises a first portion 402a, 402b in which f(z)=0. This portion of the plot corresponds to positions which are in the lower portion 226c of the fabrication volume i.e. offset by more than the second threshold from the top of the fabrication volume.

Each plot 400a, 400b has a second portion 404a, 404b which corresponds to positions which are in the intermediate portion 226b of the fabrication volume i.e. offset by more than the first threshold and less than the second threshold from the top of the fabrication volume.

Each plot 400a, 400b has a third portion 406a, 406b which corresponds to positions which are in the upper portion 226a of the fabrication volume i.e. offset by less than the first threshold from the top of the fabrication volume, and in the third portion f(z)=1.

The weighting function 400a shown in FIG. 4A has a linear transition in the second portion 404a between the first portion 402a and the third portion 406a. The weighting function 400b shown in FIG. 4B shows a smooth curved transition in the second portion 404b between the first portion 402b and the third portion 406b. In some examples, the second portion 404b may be obtained from an interval of a sinusoidal function. For example the function f(x) = ( cos( x × π/50) × 0.5 + 0.5 ) in the interval [0, 50] provides a smooth transition from f(x)=1 to f(x)=0 over the interval from x=0 to x=50.

In order to determine the geometrical compensation value to be applied at a position within the second fabrication volume, a first geometrical compensation value and second geometrical compensation value may be combined. The first geometrical compensation value may be determined as p(x,y,z+h₁-h₂) from the geometric compensation profile which is offset in the z-direction by an amount equal to the difference in height between the first and second fabrication volumes i.e. by a distance equal to h₁-h₂. The second geometrical compensation value may be determined as p(x,y,z). The first and second geometrical compensation values may be combined using either weighting function 400a, 400b according to the formula:

f( z + h₁ - h₂) ▪ p(x, y, z + h₁ - h₂) + ( 1 - f( z + h₁ - h₂)) ▪ p(x, y, z)

When z is small i.e. in the first portion of the plot (in the language of FIG. 3, the first offset is greater than the second threshold), this formula results in a geometrical compensation value equal to p(x,y,z). Therefore, the geometrical compensation value is the same as the corresponding position in the first fabrication volume.

When z is large i.e. in the third portion of the plot (in the language of FIG. 3, the first offset is less than the first threshold), this formula results in a geometrical compensation value equal to p(x, y, z + h₁ - h₂), which corresponds to a geometrical compensation value offset in the z-direction by a distance equal to the difference in depth of the first and second fabrication volumes.

When z has an intermediate value i.e. in the second portion of the plot (in the language of FIG. 3, the first offset greater than the second threshold and less than the first threshold), this formula results in a weighted combination of p(x, y, z) and p(x, y, z + h₁ - h₂). The weighting depends on the form of the function f(z).

The function f(z) shown in FIG. 4A may be relatively easier to calculate due to its linear nature in the second portion 404a, whereas the function shown in FIG. 4B may be more difficult to calculate but provides a smooth transition between the first and second portions 402b, 404b and between the second and third portions 404b, 406b. The functions shown in FIGS. 4A and 4B are examples of suitable weighting functions, however other suitable weighting functions may be used.

The values of z at which transitions between the first, second and third portions occur may be based on the depths at which cooling of build material is dominated by cooling through the upper surface of the fabrication volume and dominated by cooling through the side and bottom of the fabrication volume. For example, for z values in the first portion 402a-b cooling may be dominated by heat loss through the sides and bottom of the fabrication volume, whereas in the third portion 406a-b cooling may occur primarily through the upper surface of the fabrication volume. In the second portion 404a-b cooling may occur by heat loss through both the upper surface and through the sides and bottom of the fabrication volume. Therefore, the transitions may be determined at least partially by the thermal properties of the material used in the fabrication volume to generate objects.

In some examples the first threshold is around 50 mm. The total depth of build material used within the fabrication chamber is usually greater than this threshold, however if a depth of build material were to be used that was less than this threshold then the geometrical compensations to be applied to objects may be determined based on values corresponding to positions from the upper portion 206a of the geometric compensation profile, i.e. without a contribution corresponding to positions in the intermediate and lower portions 206b, 206c of the geometrical compensation profile.

In some examples the geometric compensation profile p(x,y,z) may comprise a plurality of defined geometrical transformation parameters (or parameter sets), each associated with different locations within the fabrication chamber. In such examples, a particular geometrical transformation parameter(s) and/or value(s) may be selected based on the intended object generation location. In some examples, defined locations or ‘nodes’ may be associated with geometrical transformation parameter(s)/value(s), and the geometrical transformation parameter(s)/value(s) to apply at locations intermediate to such defined locations may be derived for example by interpolation, or by selection of the closest defined location, or the like. The ‘nodes’ may for example be associated with locations distributed to form intersections of a grid within the fabrication chamber such that they are dispersed (for example, regularly) throughout the chamber. The model may be embodied as a look-up table or other mapping resource, mapping the locations to parameter values to be applied to the object models of objects to be generated at the location.

There may be precomputed geometrical compensation values for around 2000-5000 positions in an example fabrication volume having a size of around 380 mm x 284 mm x 380 mm, and the values for intermediate locations may be interpolated from these values. In some examples, when an object is to be generated at a location between the nodes, the method comprises interpolating a geometrical compensation value based on the geometrical transformation values associated with at least two nodes. In some examples, geometrical transformation values of the four closest nodes may be interpolated to give an average, weighted by distance from each node. To determine the geometrical compensation to apply to object model data, interpolated geometrical compensation values may be used.

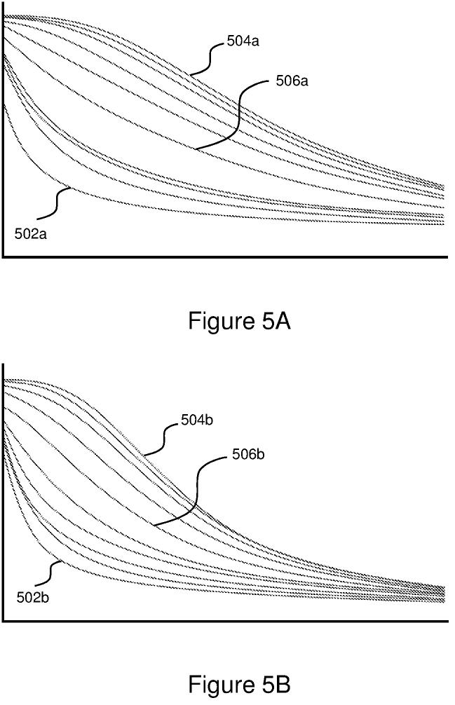

FIGS. 5A and 5B show cooling profiles for different materials in a particular example apparatus. Each is a plot with time on the horizontal axis and temperature on the vertical axis. Each line represents a temperature measurement over time, measured for a differnt layer at a different depth within a fabrication volume. Each line shows how the temperature at that position changes over time as the fabrication volume cools. Each line begins when a layer at a depth corresponding to the line is deposited. Therefore, the horizontal axis represents time since each layer was deposited. To put it another way, the time frame is shifted for each line, with t = 0 being the time at which the layer is deposited. Thus while one line may have a t = 0 which corresponds to a ‘clock’ time of 10.30 hrs and 20 seconds, another line may have a t = 0 which corresponds to a clock time of 10.31 hrs and 10 seconds, and so on. FIG. 5A shows cooling profiles for HP PA12 and FIG. 5B shows cooling profiles for a polypropylene (PP) powder build material, to demonstrate how the cooling profiles may vary based on the build material used.

The lower lines 502a, 502b correspond to the lowermost position at which the temperature was measured within the build volumes (nearest the bottom) and the upper lines 504a, 504b correspond to the uppermost position at which temperature was measured within the build volumes (nearest the top). The lower lines 502a, 502b start at relatively lower temperatures, as they correspond to layers of build material which were deposited earlier in the build process. Heat is accumulated throughout the process, so layers which are deposited later (i.e. closer to the top of the fabrication chamber) begin at a higher temperature than those which are deposited near the beginning of the process (i.e. closer to the bottom of the fabrication chamber). Effectively, the upper layers are being heated by the heat of the previously deposited layers below, as well as by an energy source which irradiates the upper surfaces.

In FIG. 5A, the middle line 506a corresponds to build material of a depth 20 mm below the upper surface of the build volume. Lines in this plot which are below this middle line 506a have a positive curvature which is indicative of cooling dominated by heat loss through the sides and bottom of the fabrication volume. In contrast lines which are above the middle line 506a have a negative curvature which is indicative of cooling dominated by heat loss through the upper surface of the fabrication volume. Therefore, by measuring the cooling profiles of different depths of build material the depths of the first threshold (and in some examples, the second threshold) may be determined.

In FIG. 5B, the middle line 506b corresponds to a depth of 30 mm. Similarly, lines below this middle line 506b have positive curvature and lines above have negative curvature. The transition between positive and negative curvature occurs at a greater depth for PP compared with PA12, therefore the first and second thresholds for PP will be greater than the corresponding thresholds for PA12. Therefore, the first and second thresholds may be based on the type of build material used to generate the objects. Furthermore, the shape of the weighting function may depend on the type of build material used. In each example the middle line 506a, 506b may define the centre of the transition portion, since for positions corresponding to lines on one side of the middle line more heat is lost through the upper surface of the build material, whereas on the other side of the middle lines more heat is lost through the side walls and bottom of the fabrication chamber. Therefore, a depth corresponding to the middle lines 506a, 506b may lie between the first threshold and the second threshold.

An example additive manufacturing apparatus is capable of producing a build volume of a depth of up to 380 mm. Therefore, the transition between the different types of cooling may occur at around 10% of the greatest possible depth below the top surface of build material. The transition may occur at different depths in different apparatus, even for a given build material.

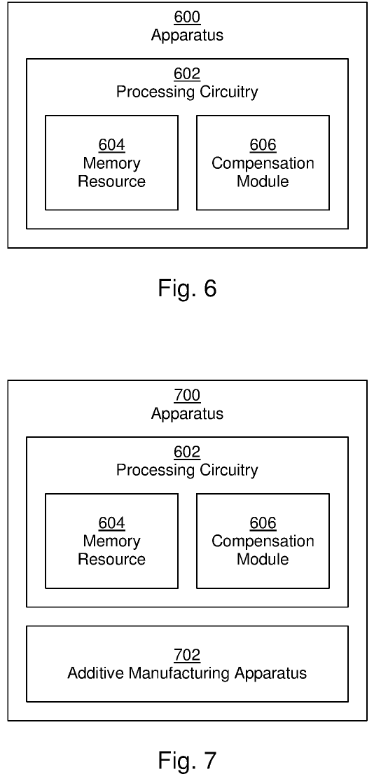

FIG. 6 shows an example of apparatus 600 comprising processing circuitry 602, the processing circuitry 602 comprising a memory resource 604 and a compensation module 606.

In use of the apparatus 600, the memory resource 604 stores geometrical compensation data defining geometrical compensations for use in compensating for anticipated deformations in objects to be generated by an additive manufacturing apparatus when a build volume having a first depth of build material is used in the fabrication chamber. The geometrical compensation data comprises geometrical compensation values associated with locations in the build volume having the first depth. The memory resource 604 may be any type of memory resource suitable for storing the geometrical compensation data, for example, a hard disk drive, solid state hard drive or flash memory. In other examples the memory resource 604 may be a volatile memory resource which obtains the geometrical compensation data, wherein the geometrical compensation data is stored externally to the apparatus 600.

In use of the apparatus 600, the compensation module 606 applies a geometrical compensation value to object model data modelling an object, wherein the object is to be generated in a build volume having a second depth of build material. In some examples the second depth of build material is less than the first depth of build material.

In the case that the object is to be built in a lower portion of the build material, the compensation module 606 is to apply a geometrical compensation value based on a geometrical compensation value for a location having a distance from the base of the build volume having the first depth corresponding to a distance of the intended object generation location from the base of the build volume having the second depth. This may be the geometrical compensation value for a location having the same x, y, and z coordinates as the intended location of object generation. The lower portion of build material may correspond to the lower portion 226c of build material shown in FIG. 2B.

In the case that the object is to be generated in an upper portion of the build material, the compensation module 606 is to apply a geometrical compensation value based on a geometrical compensation value for a location having a distance from the top of the build volume having the first depth corresponding to a distance of the intended object generation location from the top of the build volume having the second depth. This may be the geometrical compensation value for a location having the same x and y coordinates as the intended location of object generation, but a different z coordinate, such that the z coordinate has the same offset or distance from the top of the build volume as the intended location of object generation. The upper portion of build material may correspond to the upper portion 226a of build material shown in FIG. 2B. In some examples, the compensation module 606 is to apply a geometrical compensation values determined for intermediate, or transition, portions, for example based on a weighted average as described above.

For example, the apparatus 600 may carry out any of the blocks of the methods for FIG. 1 or FIG. 3 described above

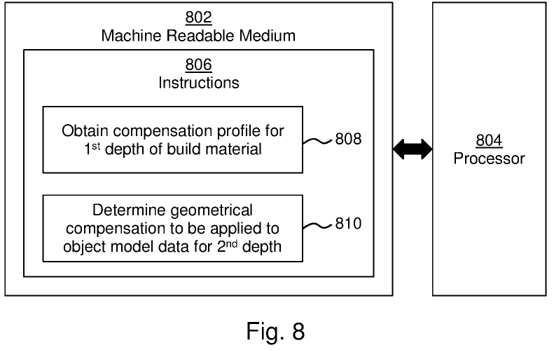

FIG. 7 shows an example of apparatus 700, which comprises the processing circuitry 602 of FIG. 6. The apparatus 700 further comprises an additive manufacturing apparatus 702 to generate objects according to object model data to which the geometrical compensation has been applied.

In some examples, when the object is to be generated in a build volume having a second depth of build material, in the case that the object is to be built in a transition portion between the upper portion and the lower portion, the compensation module 606 is to apply a geometrical compensation value based on a combination of a first geometrical compensation value and a second geometrical compensation value. The first geometrical compensation value is a geometrical compensation value for a location having a distance from the base of the build volume having the first depth corresponding to a distance of the intended object generation location from the base of the build volume having the second depth. The second geometrical compensation value is a geometrical compensation value for a location having a distance from the top of the build volume having the first depth corresponding to a distance of the intended object generation location from the top of the build volume having the second depth.

The additive manufacturing apparatus 702, in use thereof, generates the object in a plurality of layers (which may correspond to respective slices of an object model) according to object generation, or print, instructions. The print instructions (or object generation instructions) may, in use thereof, control the additive manufacturing apparatus 702 to generate each of a plurality of layers of the object. This may for example comprise specifying area coverage(s) for print agents such as fusing agents, colorants, detailing agents and the like. In some examples, object generation parameters are associated with object model sub-volumes (voxels or pixels). In some examples, the print instructions comprise a print agent amount associated with sub-volumes. In some examples, other parameters, such as any, or any combination of heating temperatures, build material choices, an intent of the print mode, and the like, may be specified. In some examples, halftoning may be applied to determined object generation parameters to determine where to place fusing agent or the like.

The additive manufacturing apparatus 702 may for example generate an object in a layer-wise manner by selectively solidifying portions of layers of build material. The selective solidification may in some examples be achieved by selectively applying print agents, for example through use of ‘inkjet’ liquid distribution technologies, and applying energy, for example heat, to the layer. The additive manufacturing apparatus 702 may comprise additional components not shown herein, for example any or any combination of a fabrication chamber, a print bed, printhead(s) for distributing print agents, a build material distribution system for providing layers of build material, energy sources such as heat lamps and the like.

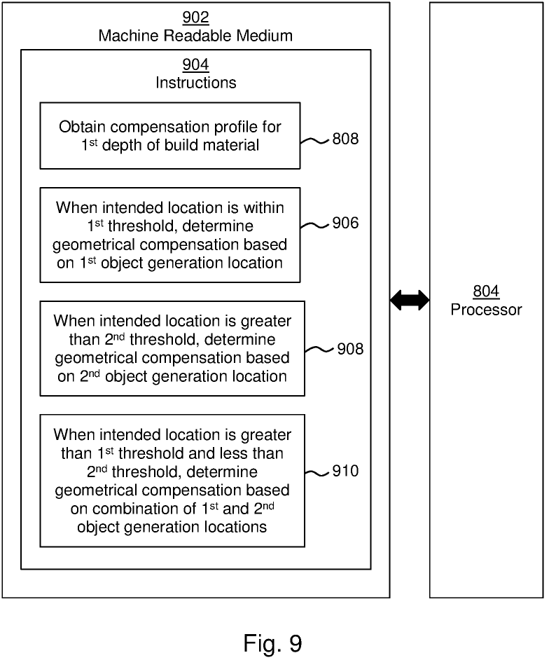

FIG. 8 shows a machine readable medium 802 associated with a processor 804. The machine readable medium 802 comprises instructions which, when executed by the processor 804, cause the processor 804 to carry out tasks.

In this example, the instructions 806 comprise instructions 808 to cause the processor 804 to obtain a compensation profile for a build chamber of an additive manufacturing apparatus in which an object is to be generated in a first depth of build material, the compensation profile specifying different geometrical compensation values for different intended object generation locations within the build chamber.

The instructions 806 further comprise instructions 810 to cause the processor 804 to determine a geometrical compensation to be applied to object model data representing a first object which is to be generated in a second depth of build material smaller than the first depth based on a geometrical compensation value associated with a first object generation location, wherein the first object generation location has an offset from an upper surface of the first depth build material and an intended location of generation of the first object has the same offset from the upper surface of the second depth of build material. The first object generation location and the intended location of generation of the first object may for example have the same x and y coordinates, but different z coordinates, wherein the z coordinates have the same offset from the upper surface of the different first and second depths.

FIG. 9 shows a machine readable medium 902 associated with a processor 804. The machine readable medium 902 comprises instructions which, when executed by the processor 804, cause the processor 804 to carry out instructions 904. The instructions 904 comprise instructions 808 as described in relation to FIG. 8.

The instructions 904 further comprise instructions 906 to, when the intended location of generation is within a first threshold distance from the upper surface, determine the geometrical compensation to be applied to object model data representing the first object based on a geometrical compensation value associated with the first object generation location.

The instructions 904 further comprise instructions 908 to, when the intended location of generation is greater than a second threshold distance from the upper surface, determine the geometrical compensation to be applied to the object model data representing the first object based on a geometrical compensation value associated with a second object generation location. The second object generation location has an offset from a lower surface of the first depth of build material and the intended location of generation of the first object has the same offset from the lower surface of the second depth of build material. The second object generation location and the intended location of generation of the first object may for example have the same x, y and z coordinates.

The instructions 904 further comprise instructions 910 to, when the intended location of generation is greater than the first threshold distance from the upper surface and less than the second threshold distance from the upper surface, determine the geometrical compensation to be applied to the object model data representing the first object based on a combination of geometrical compensation values associated with the first object generation location and with the second object generation location.

In some examples, the instructions 806, 904 when executed cause the processor 804 to carry out any of the blocks of FIGS. 1 or 3. In some examples, the instructions 806, 904 may cause the processor 804 to act as any part of the processing circuitry 602 of FIG. 6 or FIG. 7.

Examples in the present disclosure can be provided as methods, systems or machine readable instructions, such as any combination of software, hardware, firmware or the like. Such machine readable instructions may be included on a computer readable storage medium (including but not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each block in the flow charts and/or block diagrams, as well as combinations of the blocks in the flow charts and/or block diagrams can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus, functional modules of the apparatus and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by block(s) in the flow charts and/or block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method comprising:
obtaining, by processing circuitry, a geometric compensation profile characterising a relationship between a location of an object within a first fabrication volume in a fabrication chamber of an additive manufacturing apparatus, the first fabrication volume having a first depth of build material, and a geometrical compensation to be applied to a model of said object, wherein geometrical compensation values are associated with different locations;
determining, using processing circuitry, that a first object is to be generated in a first build operation, the first build operation having a second fabrication volume which has a second depth, wherein the second depth is less than the first depth; and
determining, using processing circuitry, a geometrical compensation to be applied to a model of the first object,
wherein determining the geometrical compensation comprises:
determining a first offset of the first object from the top of the second fabrication volume;
identifying, from the geometric compensation profile, the geometrical compensation value associated with a location having the first offset from the top of the first fabrication volume; and
determining the compensation to be applied to the model of the first object based on the identified geometrical compensation value.

2. A method as claimed in claim 1, wherein
determining the geometrical compensation to be applied to the model of the first object based on the identified geometrical compensation value associated with the location having the first offset is conditional on the first offset being less than a threshold.

3. A method as claimed in claim 2 comprising determining the threshold based on thermal properties of the build material.

4. A method as claimed in claim 2, further comprising:
determining if the first offset is greater than the threshold, wherein,
when the first offset is greater than the threshold identifying the geometrical compensation comprises:
determining a second offset of the first object from the bottom of the second fabrication volume;
identifying, from the geometric compensation profile, the geometrical compensation value associated with a location having the second offset from the bottom of the first fabrication volume; and
determining the compensation to be applied to the model of the first object based on the identified geometrical compensation value.

5. A method as claimed in claim 2, further comprising:
determining if the first offset is greater than a first threshold and less than a second threshold; wherein
when the first offset is greater than the first threshold and less than the second threshold identifying the geometrical compensation comprises:
identifying, from the geometric compensation profile, a first geometrical compensation value associated with a location having the first offset from the top of the first fabrication volume;
determining a second offset of the first object from the bottom of the second fabrication volume;
identifying, from the geometric compensation profile, a second geometrical compensation value associated with the location having the second offset from the bottom of the first fabrication volume; and
determining the compensation to be applied to the model of the first object by combining the first geometrical compensation value and the second geometrical compensation value to identify the geometrical compensation.

6. A method as claimed in claim 5 wherein combining the first geometrical compensation value and the second geometrical compensation value comprises:
performing a weighted combination of the first geometrical compensation value and the second geometrical compensation value.

7. A method as claimed in claim 1, further comprising applying the determined compensation to the model of the first object.

8. A method as claimed in claim 7, further comprising generating the first object after applying the determined compensation to the model of the first object.

9. An apparatus comprising processing circuitry, the processing circuitry comprising:
a memory resource storing geometrical compensation data defining geometrical compensations for use in compensating for anticipated deformations in objects to be generated by an additive manufacturing apparatus when a build volume having a first depth of build material is used in the fabrication chamber, the geometrical compensation data comprising geometrical compensation values associated with locations in the build volume having the first depth; and
a compensation module to apply a geometrical compensation value to object model data, wherein, when the object is to be generated in a build volume having a second depth of build material:
in the case that the object is to be built in a lower portion of the build material, the compensation module is to apply a geometrical compensation value based on a geometrical compensation value for a location having a distance from the base of the build volume having the first depth corresponding to a distance of the intended object generation location from the base of the build volume having the second depth; and
in the case that the object is to be built in an upper portion of the build material, the compensation module is to apply a geometrical compensation value based on a geometrical compensation value for a location having a distance from the top of the build volume having the first depth corresponding to a distance of the intended object generation location from the top of the build volume having the second depth.

10. An apparatus as claimed in claim 9 further comprising additive manufacturing apparatus.

11. An apparatus as claimed in claim 9, wherein, when the object is to be generated in a build volume having a second depth of build material:
in the case that the object is to be built in a transition portion between the upper portion and the lower portion, the compensation module is to apply a geometrical compensation value based on a combination of:
a geometrical compensation value for a location having a distance from the base of the build volume having the first depth corresponding to a distance of the intended object generation location from the base of the build volume having the second depth; and
a geometrical compensation value for a location having a distance from the top of the build volume having the first depth corresponding to a distance of the intended object generation location from the top of the build volume having the second depth.

12. A non-transitory machine-readable medium storing instructions which, when executed by a processor, cause the processor to:
obtain a compensation profile for a build chamber of an additive manufacturing apparatus in which an object is to be generated in a first depth of build material, the compensation profile specifying different geometrical compensation values for different intended object generation locations within the build chamber; and
determine a geometrical compensation to be applied to object model data representing a first object which is to be generated in a second depth of build material smaller than the first depth based on a geometrical compensation value associated with a first object generation location,
wherein the first object generation location has an offset from an upper surface of the first depth of build material and an intended location of generation of the first object has the same offset from the upper surface of the second depth of build material.

13. A non-transitory machine-readable medium according to claim 12:
wherein determining the geometrical compensation to be applied to object model representing the first object based on a geometrical compensation value associated with a first object generation location is conditional on the intended location of generation being within a first threshold distance from the upper surface.

14. A non-transitory machine-readable medium according to claim 13 further comprising instructions to cause the processor to:
when the intended location of generation is greater than a second threshold distance from the upper surface,
determine the geometrical compensation to be applied to the object model data representing the first object based on a geometrical compensation value associated with a second object generation location,
wherein the second object generation location has an offset from a lower surface of the first depth of build material and the intended location of generation of the first object has the same offset from the lower surface of the second depth of build material.

15. A machine-readable medium according to claim 14 further comprising instructions to cause the processor to:
when the intended location of generation is greater than the first threshold distance from the upper surface and less than the second threshold distance from the upper surface,
determine the geometrical compensation to be applied to the object model data representing the first object based on a combination of geometrical compensation values associated with the first object generation location and with the second object generation location.
